(19) United States
(12) Patent Application Publication
(10) Pub. No.: US 2006/0083966 A1
(43) Pub. Date: Apr. 20, 2006

(54) Fuel cell unit and method for controlling liquid volume

(75) Inventor: Akihiro Ozeki, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/239,225

(22) Filed: Sep. 30, 2005

(30) Foreign Application Priority Data
Sep. 30, 2004 (JP) 2004-289285

(51) Int. Cl. H01M 8/04; H01M 8/12

(52) U.S. Cl. 429/22; 429/26

(57) ABSTRACT

A fuel cell unit including: a fuel cell which generates water vapor; a mixing tank which mixes fuel and water so as to produce an aqueous fuel solution, the water in the mixing tank includes water generated by condensation of the water vapor; and a controller which controls the condensation of the water vapor so that a volume of the aqueous fuel solution in the mixing tank falls within a predetermined range.

### CROSS-REFERENCE TO RELATED APPLICATIONS

This application is based upon and claims the benefit of priority from the prior Japanese Patent Application No. 2004-289285, filed on Sep. 30, 2004; the entire contents of which are incorporated herein by reference.

### BACKGROUND

1. Field

The present invention relates to a fuel cell unit, such as a direct methanol fuel cell unit; and to a method for controlling a liquid volume.

2. Description of the Related Art

Among variety types of fuel cells, a direct methanol fuel cell (DMFC) is exemplified as one type of fuel cell appropriate for use in an information processing apparatus. A fuel cell of this type adopts a dilution circulation system. In the system, a low-concentration aqueous methanol solution circulates. When methanol is consumed in the course of power generation, high-concentration methanol is replenished; and when water is consumed, water obtained by means of recovering water produced in chemical reaction is replenished. For this purpose, there is provided a mixing tank for mixing high-concentration methanol to be replenished with water, thereby producing an aqueous methanol solution.

As a method for recovering water, there is employed, for instance, a method in which water vapor having been delivered from a fuel cell is cooled by a cooling fan and condensed, thereby obtaining water. In this case, a volume of water varies depending on the outside temperature, a rotation speed of the cooling fan, and the like. In addition, the system takes in the outside air for the purpose of using oxygen therein. Accordingly, the volume of water is also affected by the humidity of the outside air. As a result, the liquid volume in the mixing tank varies. However, since the mixing tank is of limited capacity, when a liquid level rises excessively, overflow will occur. In contrast, when the liquid level falls excessively, normal power generation will be inhibited. Therefore, control for preventing excessive rise and fall of the liquid level must be performed. In addition, a case where the above-described control has already become impossible to perform, a safety measure must be taken so as to prevent a problem or the like which may otherwise arise.

Incidentally, example techniques for controlling a liquid volume in a tank include that disclosed in JP-A-5-258760. JP-A-5-258760 discloses a control method in which a fuel temperature in a fuel tank is measured by a thermometer at predetermined time intervals; and when the liquid temperature increases above a predetermined value, pure water in a water tank is supplied to the fuel tank, and when the same is at or below a lower limit value, liquid fuel inside a reserve fuel tank is supplied to the fuel tank.

### BRIEF SUMMARY

However, according to the control technique disclosed in JP-A-5-258760, which depends merely on a liquid temperature, control for preventing excessive rise or fall of a liquid level cannot be performed, and a case where this control becomes impossible cannot be handled in a safe manner.

The present invention has been conceived in view of the above circumstances, and aims at providing a fuel cell unit which can perform appropriate processing in accordance with a volume of an aqueous fuel solution in a mixing tank, as well as a method for controlling the liquid volume.

### BRIEF DESCRIPTION OF THE DRAWINGS

FIG. 1 is an external view showing a fuel cell unit according to an embodiment of the present invention;

FIG. 2 is an external view showing a state in which an information processing apparatus is connected to the fuel cell unit;

FIG. 3 is a system diagram primarily showing the configuration of a power generation section of the fuel cell unit;

FIG. 4 is a system diagram showing a state in which the information processing apparatus is connected to the fuel cell unit;

FIG. 5 is a system diagram showing the configuration of the fuel cell unit and the information processing apparatus;

FIG. 6 is a state transition diagram of the fuel cell unit and the information processing apparatus;

FIG. 7 is a view showing a primary control command set for the fuel cell unit;

FIG. 8 is a view showing a primary power supply data set pertaining to the fuel cell unit;

FIG. 9 is a schematic view showing modes of control performed in accordance with a volume of a methanol aqueous solution in a mixing tank shown in FIG. 3;

FIG. 10 is a flowchart showing operations of liquid volume control performed by a fuel cell control section shown in FIG. 3; and

FIG. 11 is a view for explaining a method for allowing a tolerance in relation to a threshold value.

### DETAILED DESCRIPTION

An embodiment of the present invention will be described with reference to the drawings.

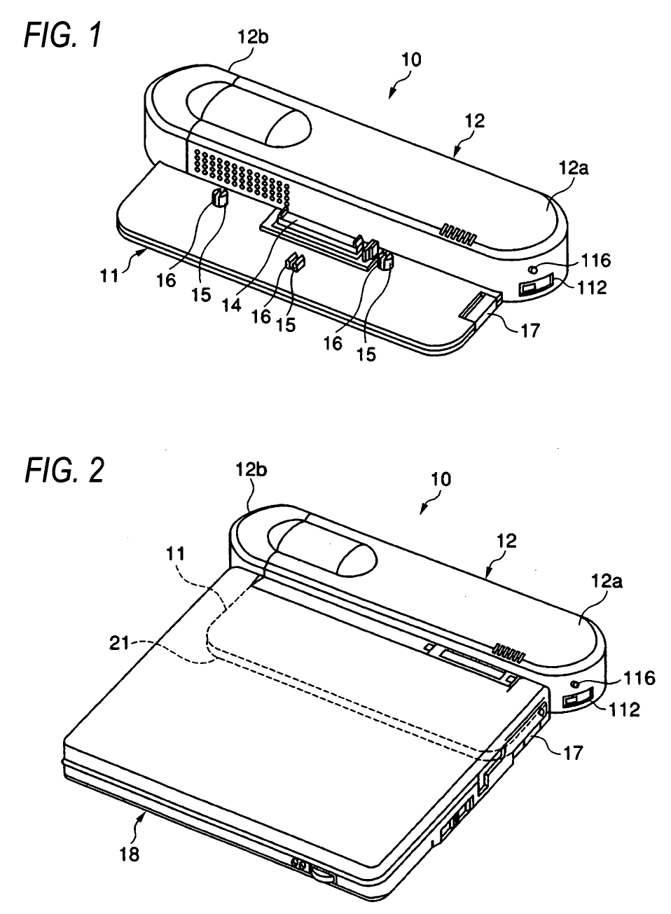

FIG. 1 is an external view showing a fuel cell unit according to the embodiment of the present invention. As shown in FIG. 1, the fuel cell unit 10 comprises a mount section 11 for mounting thereon a rear section of an information processing apparatus, such as a notebook computer; and a fuel cell unit main body 12. The fuel cell unit main body 12 incorporates a DMFC stack for generating power through electrochemical reaction; and auxiliary devices (pumps, valves, and the like) for injecting methanol and air, which serve as fuel, into the DMFC stack, and circulating the same.

A detachable fuel cartridge (not shown) is incorporated, for instance, at the left end, inside of a unit case 12a of the fuel cell unit main body 12. A cover 12b is removably configured so as to allow replacement of the fuel cartridge.

An information processing apparatus is mounted on the mount section 11. On the upper face of the mount section 11, a docking connector 14 is disposed as a connecting section for establishing connection with the information processing apparatus. Meanwhile, a docking connector 21 (not shown) serving as a connecting section for establishing connection with the fuel cell unit 10 is disposed, for instance, on a rear section of the bottom face of the information processing apparatus. Hence, mechanical and electrical connection with the docking connector 14 of the fuel cell unit 10 is established. In addition, a pair constituted of a positioning projection 15 and a hook 16 is disposed at each of three positions on the mount section 11. The positioning projections 15 and the hooks 16 are inserted in holes formed in the rear section of the bottom face of the information processing apparatus at three positions corresponding to the positioning projections 15 and the hooks 16.

For detachment of the information processing apparatus from the fuel cell unit 10, an eject button 17 on the fuel cell unit 10 shown in FIG. 2 is to be pushed. By means of this pushing action, a locking mechanism (not shown) is released, and detachment can be achieved easily.

A power-generation setting switch 112 and a fuel cell operation switch 116 are disposed on, for instance, the right side face of the fuel cell unit main body 12.

The power-generation setting switch 112 is a switch for enabling a user to set allowance or prohibition of power generation by the fuel cell unit 10 in advance. The power-generation setting switch 112 is embodied as, for instance, a sliding switch.

The fuel cell operation switch 116 is used in such a case that, for instance, during operation of an information processing apparatus 18 on electric power generated by the fuel cell unit 10, only power generation by the fuel cell unit 10 is to be stopped while operation of the information processing apparatus 18 is continued. In this case, the information processing apparatus 18 continues its operation on electric power of an incorporated secondary battery. The fuel cell operation switch 116 is embodied as, for instance, a push switch.

FIG. 2 is an external view showing a state in which the information processing apparatus 18 (e.g., a notebook personal computer) is mounted on and connected with the mount section 11 of the fuel cell unit 10.

Meanwhile, the fuel cell unit 10 shown in FIGS. 1 and 2 can assume a variety of shapes and sizes; and the docking connector 14 shown in the same can assume a variety of shapes, positions, and the like.

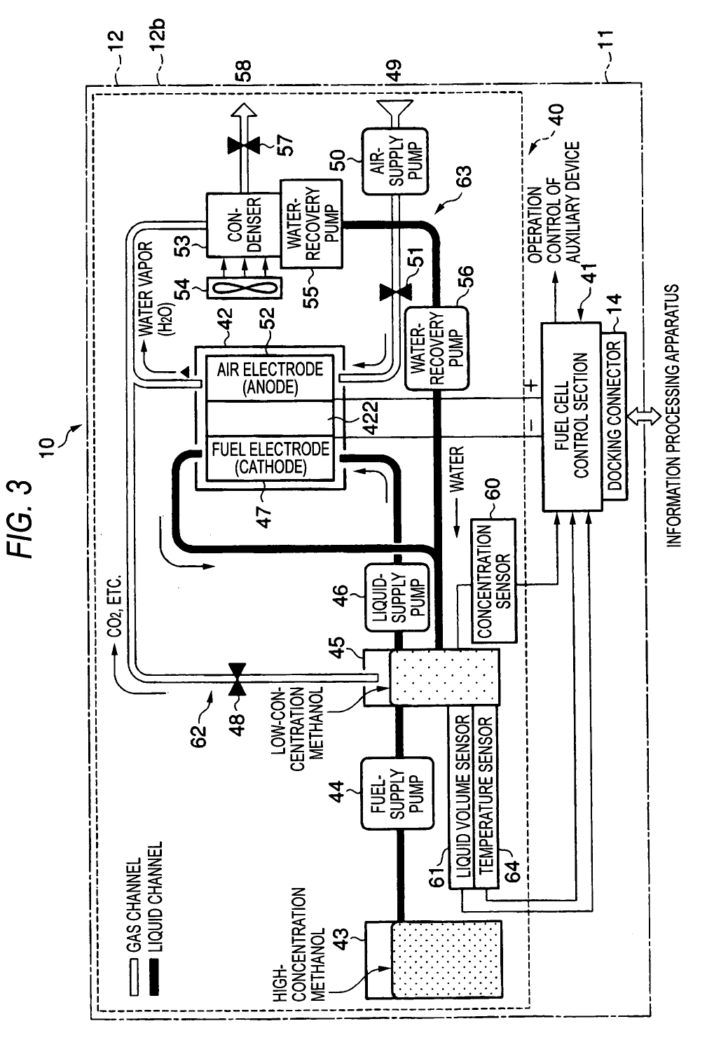

FIG. 3 shows a system diagram of the fuel cell unit 10, particularly showing in detail a system pertaining to a DMFC stack and auxiliary devices disposed on the periphery of the DMFC stack.

The fuel cell unit 10 comprises a power generation section 40, and a fuel cell control section 41 serving as a control section of the fuel cell unit 10. The fuel cell control section 41 controls the power generation section 40, and also functions as a communication control section for carrying out communication with the information processing apparatus 18.

The power generation section 40 has therein a fuel cartridge 43 for containing methanol serving as fuel, in addition to having a DMFC stack 42 serving as the center for generating power. High-concentration methanol is sealed in the fuel cartridge 43. The fuel cartridge 43 is detachably configured so as to allow easy replacement when fuel is consumed.

Generally, in a direct methanol fuel cell, a methanol crossover phenomenon must be suppressed for the purpose of enhancing power generation efficiency. To this end, a method of diluting high-concentration methanol, thereby obtaining low-concentration methanol, and injecting the low-concentration methanol into a fuel electrode 47 is effective. To achieve this, the fuel cell unit 10 adopts a diluting circulation system 62; and auxiliary devices 63 necessary for embodying the diluting circulation system 62 are disposed in the power generation section 40.

Some of the auxiliary devices 63 are disposed in a fluid channel, and the others are disposed in a gas channel.

Connection relationships of the auxiliary devices 63 disposed in the liquid channel are as follows. Pipe connection is established from an output section of the fuel cell cartridge 43 to a fuel-supply pump 44. Further, an output section of the fuel-supply pump 44 is connected to a mixing tank 45. Further, an output section of the mixing tank 45 is connected to a liquid-supply pump 46. An output section of the liquid-supply pump 46 is connected to the fuel electrode 47 in the DMFC stack 42. Pipe connection is established between an output section of the fuel electrode 47 and the mixing tank 45. Pipe connection is established between an output section of a water-recovery tank 55 and a water-recovery pump 56. The water-recovery pump is connected to the mixing tank 45.

Meanwhile, in the gas channel, an air-supply pump 50 is connected to an air electrode 52 in the DMFC stack 42 by way of an air-supply valve 51. An output section of the air electrode 52 is connected to a condenser 53. The mixing tank 45 is also connected to the condenser 53 by way of a mixing-tank valve 48. The condenser 53 is connected to an air-exhaust port 58 by way of an air-exhaust valve 57. Fins for effectively condensing water vapor are disposed in the condenser 53. A cooling fan 54 is disposed in the vicinity of the condenser 53.

Next, a mechanism of power generation by the power generation section 40 in the fuel cell unit 10 will be described, along with flows of fuel and the air (oxygen).

First, high-concentration methanol in the fuel cartridge 43 is fed into the mixing tank 45 by means of the fuel-supply pump 44. In the mixing tank 45, the high-concentration methanol is mixed with recovered water and low-concentration methanol (unreacted product from power-generating reaction) supplied from the fuel electrode 47 to thus be diluted, thereby producing low-concentration methanol. The concentration of the low-concentration methanol is controlled so as to maintain a concentration value (e.g., 3 to 6%) where power generation efficiency is high. This concentration control is achieved, e.g., as follows: the fuel cell control section 41 controls the volume of high-concentration methanol to be supplied to the mixing tank 45 with use of the fuel-supply pump 44 on the basis of a result of detection by a concentration sensor 60. Alternatively, the concentration control can be achieved by means of controlling the volume of water to be re-circulated to the mixing tank 45 with use of the water-recovery pump 56, or the like.

The mixing tank 45 includes a liquid volume sensor 61 for detecting a volume of a methanol aqueous solution in the mixing tank 45, and a temperature sensor 64 for detecting a temperature. Results of detection by these devices are transmitted to the fuel cell control section 41, thereby being utilized for control of the power generation section 40, and the like.

A methanol aqueous solution diluted in the mixing tank 45 is compressed by the liquid-supply pump 46, and injected in the fuel electrode (cathode) 47 in the DMFC stack 42. In the fuel electrode 47, methanol reacts with oxygen, to thus generate electrons. Hydrogen ions (H+) generated in the oxidation reaction permeate a solid polymer electrolyte membrane 422 in the DMFC stack 42, and reach the air electrode (anode) 52.

Meanwhile, carbon dioxide produced in the oxidation reaction in the fuel electrode 47 recirculates to the mixing tank 45 along with a methanol aqueous solution not having undergone the reaction. Carbon dioxide is evaporated in the mixing tank 45; fed to the condenser 53 by way of the mixing-tank valve 48; and eventually exhausted to the outside through the air-exhaust port 58 by way of the air-exhaust valve 57.

Meanwhile, the flow of the air (oxygen) is as follows. The air is taken from an air-intake port 49; compressed by the air-supply pump 50; and injected in the air electrode (anode) 52 by way of the air-supply valve 51. In the air electrode 52, reduction reaction of the oxygen (O₂) proceeds, thereby producing water (H₂O), in the form of water vapor, from electrons (e⁻) supplied from an external load, hydrogen ions (H⁺) supplied from the fuel electrode 47, and the oxygen (O₂). The water vapor is discharged from the air electrode 52, and enters the condenser 53. In the condenser 53, the water vapor is cooled by the cooling fan 54, condensed into water (liquid), and temporarily stored in the water recovery tank 55. The thus-recovered water is re-circulated to the mixing tank 45 by means of the water-recovery pump 56. Thus, the diluting circulation system 62 for diluting high-concentration methanol is configured.

As is apparent in the mechanism of power generation by the fuel cell unit 10 with use of the diluting circulation system 62, the auxiliary devices 63, such as the pumps 44, 46, 50, 56, the valves 48, 51, 57, the cooling fan 54, and the like of the respective sections are activated so as to obtain electric power from the DMFC stack; namely, to start power generation. Accordingly, a methanol aqueous solution and the air (oxygen) are injected into the DMFC stack 42, where electric power is obtained as a result of electrochemical reaction. Meanwhile, termination of power generation is effected by means of stopping operations of the auxiliary devices 63.

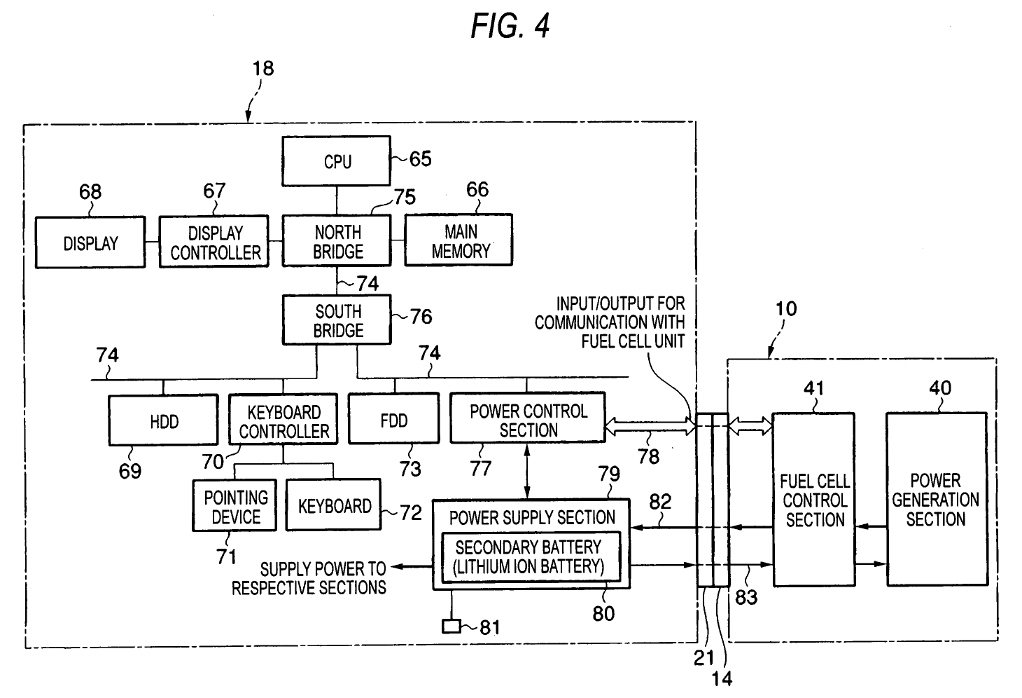

FIG. 4 shows a system configuration of the information processing apparatus 18 to which the fuel cell unit 10 according to the present invention is to be connected.

The information processing apparatus 18 comprises a CPU 65; a main memory 66; a display controller 67; a display 68; an HDD (hard disk drive) 69; a keyboard controller 70; a pointing device 71; a keyboard 72; an FDD 73; buses 74 for transmitting signals between these elements; devices, known as a north bridge 75 and a south bridge 76, which convert signals transmitted by way of the buses 74; and the like. Inside the information processing apparatus 18, there is provided a power supply section 79, where, for instance, a lithium ion battery is contained as a secondary battery 80. The power supply section 79 is controlled by a control section 77 (hereinafter called a “power control section 77”).

As electrical interfaces between the fuel cell unit 10 and the information processing apparatus 18, a control system interface and a power supply system interface are provided. The control system interface is an interface provided for carrying out communication between the power control section 77 of the information processing apparatus 18 and the control section 41 of the fuel cell unit 10. Communication between the information processing apparatus 18 and the fuel cell unit 10 by way of the control system interface is carried out by way of serial buses, such as an I2C bus 78.

The power supply system interface is an interface provided for supplying electric power from the fuel cell unit 10 to the information processing apparatus 18. For instance, electric power generated in the DMFC stack 42 of the power generation section 40 is supplied to the information processing apparatus 18 by way of the control section 41 (hereinafter denoted a “fuel cell control section 41”), and the docking connector 14 and a docking connector 21. The power supply system interface also includes electric power supply 83 from the power supply section 79 of the information processing apparatus 18 to the auxiliary devices 63 in the fuel cell unit 10, and the like.

Meanwhile, direct-current power having been AC/DC converted by way of an AC-adapter connector 81 is supplied to the power supply section 79 of the information processing apparatus 18, thereby enabling operation of the information processing apparatus 18, and charging of the secondary battery (the lithium ion battery) 80.

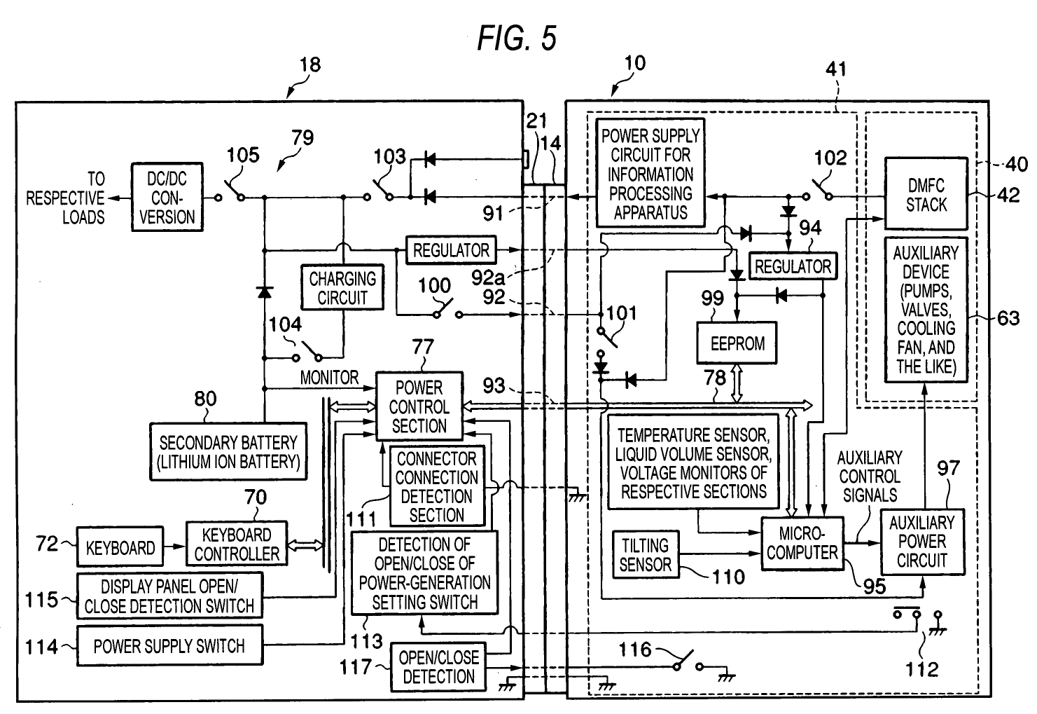

FIG. 5 is an example configuration showing a connection relationship between the fuel cell control section 41 of the fuel cell unit 10 and the power supply section 79 of the information processing apparatus 18.

The fuel cell unit 10 and the information processing apparatus are mechanically and electrically connected by means of the docking connectors 14 and 21. Each of the docking connectors 14 and 21 has a first power supply terminal (output power supply terminal) 91 for supplying electric power generated in the DMFC stack 42 in the fuel cell unit 10 to the information processing apparatus 18; and a second power supply terminal (auxiliary input power supply terminal) 92 for supplying electric power to a microcomputer 95 in the fuel cell unit 10 by way of a regulator 94, and for supplying electric power to an auxiliary power supply circuit 97 by way of a switch 101. In addition, each of the docking connectors 14 and 21 has a third power supply terminal for supplying electric power from the information processing apparatus 18 to an EEPROM 99.

Furthermore, each of the docking connectors 14 and 21 has a communication input/output terminal 93 for carrying out communication between the power control section 77 of the information processing apparatus 18 and the microcomputer 95 in the fuel cell unit 10, as well as communication between the power control section 77 and the writable, non-volatile memory (EEPROM) 90.

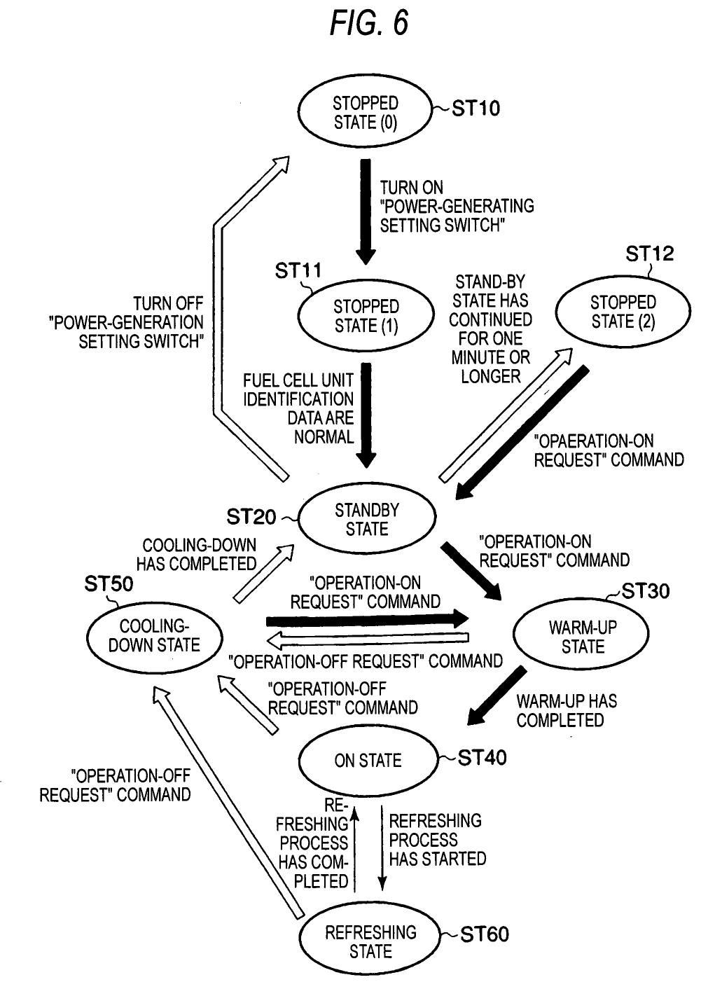

Next, with reference to the connection diagram shown in FIG. 5 and a state transition diagram of the fuel cell unit 10 shown in FIG. 6, there will be described a basic process flow through supply of electric power of the DMFC stack 42 disposed in the fuel cell unit 10 from the fuel cell unit 10 to the information processing apparatus 18.

Meanwhile, the secondary battery (lithium ion battery) 80 of the information processing apparatus 18 is assumed to have been charged with a predetermined electric power. In addition, all the switches in FIG. 5 are assumed to be open.

First, the information processing apparatus 18 detects that the information processing apparatus 18 and the fuel cell unit 10 are mechanically and electrically connected, on the basis of a signal output from a connector connection detection section 111. This detection is performed, for instance, through detection by the connector connection detection section 111 of achievement of grounding inside the fuel cell unit 10 as a result of connection of the docking connector 14 and 21, on the basis of a signal input in the connector connection detection section 111.

The power control section 77 of the information processing apparatus 18 recognizes whether the power-generation setting switch 112 of the fuel cell unit 10 is set to a power-generation-allowance setting or to a power-generation-prohibition setting. For instance, whether or not a power-generation-setting switch detection section 113 is at a grounding state or an open state in accordance with a setting state of the power-generation setting switch 112 is detected on the basis of a signal input in the power-generation-setting switch detection section 113. When the power-generation setting switch 112 is at an open state, the power control section 77 recognizes the setting as the power-generation-prohibition setting.

The state where the power-generation setting switch 112 is at the power-generation-prohibition setting is a state corresponding to a “stopped state (0)” ST10 in the state transition diagram shown in FIG. 6.

When the information processing apparatus 18 and the fuel cell unit 10 are mechanically connected by way of the docking connectors 14 and 21, electric power is supplied from the information processing apparatus 18 to the non-volatile memory (EEPROM) 99, which is a memory section of the fuel cell control section 41, by way of a third power supply terminal 92a. Identification data pertaining to the fuel cell unit 10, and the like, are stored in the EEPROM 99 in advance. The identification data can be caused to include information, such as a part code, a manufacturing serial number, and a rated power of the fuel cell unit, in advance. In addition, the EEPROM 99 is connected to serial buses, such as an I2C bus 93. Accordingly, data stored in the EEPROM 99 can be retrieved in a state in which electric power is supplied to the EEPROM 99. In the configuration shown in FIG. 5, the power control section 77 can retrieve data in the EEPROM 99 by way of the communication input/output terminal 93.

In this state, the fuel cell unit 10 is not generating power; and a state inside the fuel cell unit 10 is such that no electric power is supplied therefrom, except for the power for the EEPROM 99.

At this time, when a user sets the power-generation setting switch 112 to the power-generation-allowance setting (i.e., sets the power-generation setting switch to the grounding state in FIG. 5), the power control section 77 disposed in the information processing apparatus 18 becomes capable of retrieving identification data stored in the EEPROM 99 disposed in the fuel cell unit 10. This state corresponding to a “stopped state (1)” ST11 in FIG. 6.

In other words, so long as the user does not set the power-generation setting switch 112 to the power-generation-allowance setting; that is, so long the state remains in the power-generation-prohibition setting, the state remains at the “stopped state (0)” ST10, whereby power generation by the fuel cell unit 10 can be prohibited.

Meanwhile, the power-generation setting switch is preferably capable of being held at either the open state or the close state, in the manner of, for instance, a sliding switch.

The power control section 77 retrieves identification data by means of retrieving identification data, which are stored in the EEPROM 99 disposed in the fuel cell unit 10, pertaining to the fuel cell unit 10 by way of serial buses, such as the I2C bus 78.

When a determination is made, on the basis of the identification data retrieved by the power control section 77, that the fuel cell unit 10 being connected to the information processing apparatus 18 is a fuel cell unit compliant with the information processing apparatus 18, the state shown in FIG. 6 transits from the “stopped state (1)” ST11 to a “standby state” ST20.

More specifically, the power control section 77 disposed in the information processing apparatus 18 closes a switch 100 disposed in the information processing apparatus 18, thereby supplying electric power of the secondary battery 80 to the fuel cell unit 10 by way of the second power supply terminal 92. Accordingly, electric power is supplied to the microcomputer 95 by way of the regulator 94.

In the “standby state” ST20, the switch 101 disposed in the fuel cell unit 10 is open; and electric power is not supplied to the auxiliary power supply circuit 97. Accordingly, in this state, the auxiliary devices 63 are not in operation.

However, the microcomputer 95 has already started operation, and is capable of receiving various control commands from the power control section 77 disposed in the information processing apparatus 18 by way of the I2C bus 78. In addition, the microcomputer 95 is in such a state as to be capable of transmitting power supply data pertaining to the fuel cell unit 10 to the information processing apparatus 18 by way of I2C buses.

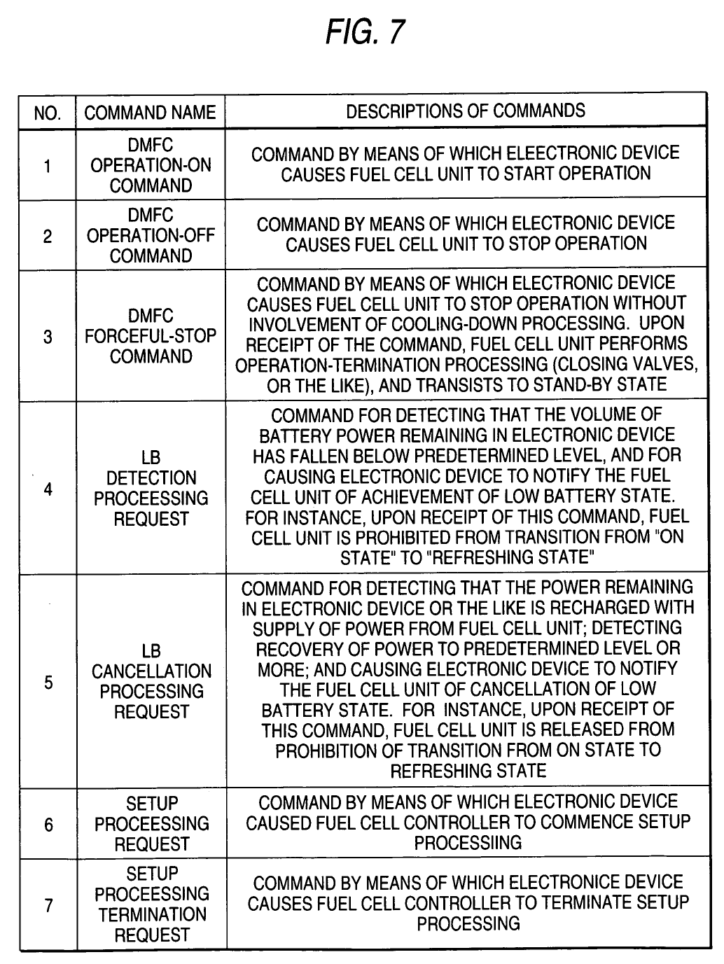

FIG. 7 shows an example control command set to be transmitted from the power control section 77 disposed in the information processing apparatus 18 to the microcomputer 95 disposed in the fuel cell control section 41.

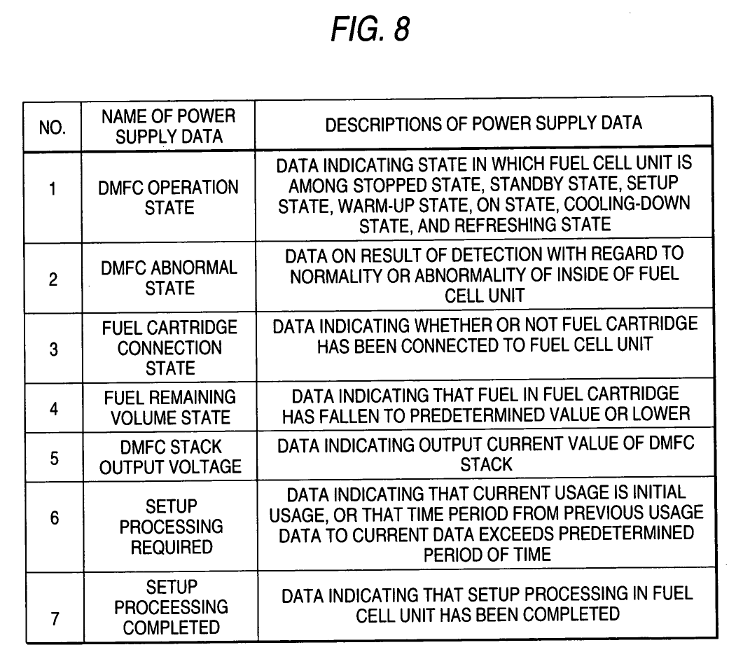

FIG. 8 shows an example power supply data set to be transmitted from the microcomputer 95 disposed in the fuel cell control section 41 to the power control section 77 disposed in the information processing apparatus 18.

The power control section 77 disposed in the information processing apparatus 18 retrieves data pertaining to a “DMFC operation state” (numeral 1 in FIG. 8) among the power supply data set shown in FIG. 8, thereby recognizing that the fuel cell unit 10 is in the “standby state” ST20.

In the “standby state” ST20, when the power control section 77 transmits to the fuel cell control section 41 a “DMFC operation-on request” command (i.e., a power-generation start command) among the control command set shown in FIG. 7, upon receipt thereof, the fuel cell control section 41 causes the state of the fuel cell unit 10 to transit to a “warm-up state” ST30.

More specifically, in accordance with control performed by the microcomputer 95, the switch 101 disposed in the fuel cell control section 41 is closed, whereby electric power is supplied from the information processing apparatus 18 to the auxiliary power supply circuit 97. In conjunction therewith, in accordance with auxiliary control signals transmitted from the microcomputer 95, the auxiliary devices 63 disposed in the power generation section 40; that is, the respective pumps 44, 46, 50, 56, the valves 48, 51, 57, the cooling fan 54, and the like, shown in FIG. 4 are activated. Furthermore, the microcomputer 95 closes a switch 102 disposed in the fuel cell control section 41.

As a result, a methanol aqueous solution and the air are injected in the DMFC stack 42 disposed in the power generation section 40, thereby starting power generation. In addition, supply of electric power generated by the DMFC stack 42 is started. However, power output does not reach a rated value instantly. Accordingly, a state in effect until the power output reaches the rated value is referred to as the “warm-up state” ST30.

When the microcomputer 95 determines that an output from the DMFC stack 42 has reached the rated value, by means of, for instance, monitoring an output voltage of the DMFC stack 42 and a temperature of the DMFC stack, the microcomputer 95 opens the switch 101 disposed in the fuel cell unit 10, thereby switching a power supply source to the auxiliary devices 63 from the information processing apparatus 18 to the DMFC stack 42. This state is an “ON state” ST40.

The above is an outline of the process flow from the “stopped state” ST10 to the “ON state” ST 40.

Hereinbelow, control of a liquid volume (or a liquid level) of a methanol aqueous solution in the mixing tank 45 will be described.

As previously described with reference to FIG. 3, the liquid volume sensor 61 for detecting a volume of a methanol aqueous solution is disposed in the mixing tank 45. A result of detection by the liquid volume sensor 61 is transmitted to the fuel cell control section 41. On the basis of a result of detection by the liquid volume sensor 61, the fuel cell control section 41 controls the volume of water (i.e., the volume of water to be fed into the mixing tank) to be recovered by way of the condenser 53 and the water-recovery tank 55 so that a volume of the methanol aqueous solution in the mixing tank 45 falls within a predetermined range. For instance, the volume of water is increased or decreased by means of increasing or decreasing a rotation speed of the cooling fan 54, stopping the rotation of the same, increasing or decreasing an output of the air-feed pump 50, and the like.

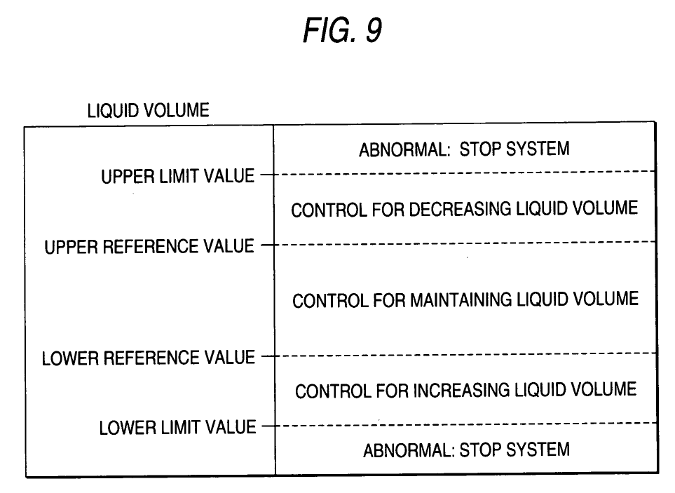

FIG. 9 is a schematic view showing modes of control in accordance with a volume of the methanol aqueous solution in the mixing tank 45. As shown in FIG. 9, for liquid levels of the methanol aqueous solution, there are provided threshold values constituted of, for instance, four values: a lower limit value, a lower reference value, an upper reference value, and an upper limit value.

When the liquid level is between the lower reference value and the upper reference value, the liquid volume is considered adequate, and a steady operation for maintaining the liquid volume constant is continued.

When the liquid level is above the upper reference value, the methanol aqueous solution in the mixing tank 45 is determined to be redundant, and control for reducing the liquid volume is performed. In this case, the fuel cell control section 41 causes operation of the cooling fan 54 to stop, and/or, on some occasions, causes an output of the air-supply pump 50 to increase, thereby increasing the volume of water vapor to be discharged to the outside (i.e., evaporating water), and the like, to thus decrease the volume of water vapor condensed in the condenser 53, and decrease a volume of water in the water-recovery tank 55.

When the liquid level is above the upper limit value, the current state is determined to be abnormal, and on the verge of overflow of the methanol aqueous solution from the mixing tank 45. Accordingly, control for stopping a power-generation operation by the power generation section (power generation system) 40 is performed.

On the other hand, when the liquid level is below the lower reference value, the methanol aqueous solution in the mixing tank 45 is determined to be insufficient, and control for increasing the liquid volume is performed. In this case, the fuel cell control section 41 causes a volume of water to increase by means to of maximizing an operation of the cooling fan 54, or on some occasions, by means of increasing an output power of the DMFC stack 42, and/or decreasing an output power of the air-feed pump 50.

When the liquid level is below the lower limit value, the current state is determined to be abnormal, and on the verge of the methanol aqueous solution being depleted in the mixing tank 45. Hence, control for stopping a power-generation operation by the power generation section (power generation system) 40 is performed.

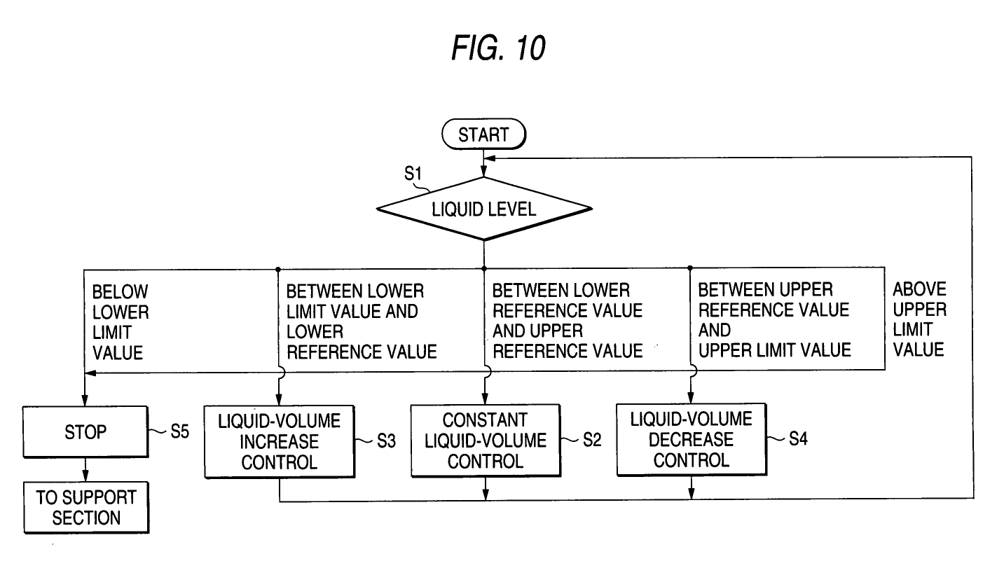

Next, operations of liquid volume control by the fuel cell unit 41 will be described with reference to a flowchart shown in FIG. 10.

The current state in the fuel cell unit 10 is assumed to be the “ON state” ST40 (see FIG. 6) in which the DMFC stack 42 is under normal power-generation operation, and the fuel cell control section 41 is monitoring a liquid level of a methanol aqueous solution in the mixing tank 45 by way of the liquid volume sensor 61 (step S1).

For instance, when the liquid level is detected to be between the lower reference value and the upper reference value, the fuel cell control section 41 determines that the liquid volume is adequate, and executes “constant liquid-volume control” so as to maintain the liquid volume as is (step S2). Thereafter, the flow returns to processing pertaining to step S1.

When the liquid level is detected to be between the lower limit value and the lower reference value, the fuel cell control section 41 determines that the liquid volume is insufficient, and executes “liquid-volume increase control” so as to increase the liquid volume (step S3). Thereafter, the flow returns to processing pertaining to step S1.

When the liquid level is detected to be below the lower limit value, the fuel cell control section 41 determines that the current state is abnormal and on the verge of the methanol aqueous solution being depleted in the mixing tank 45, and stops power-generation operation by the power generation section (power generation system) 40 (step S5) In such a case, the fuel cell unit is handed over to, for instance, a support section of a manufacturer, and services for recovery are performed.

When the liquid level is detected to be between the upper reference value and the upper limit value, the methanol aqueous solution in the mixing tank 45 is determined to be redundant, and “liquid-volume decrease control” is carried out so as to decrease the liquid volume (step S4). Thereafter, the flow returns to processing pertaining to step S1.

When the liquid level is detected to be above the upper limit value, the fuel cell control section 41 determines that the current state is abnormal, and on the verge of overflow of the methanol aqueous solution out of the mixing tank 45, and stops power-generation operation by the power generation section (power generation system) 40 (step S5). In such a case, the fuel cell unit is handed over to, for instance, a support section of a manufacturer, and services for recovery are performed.

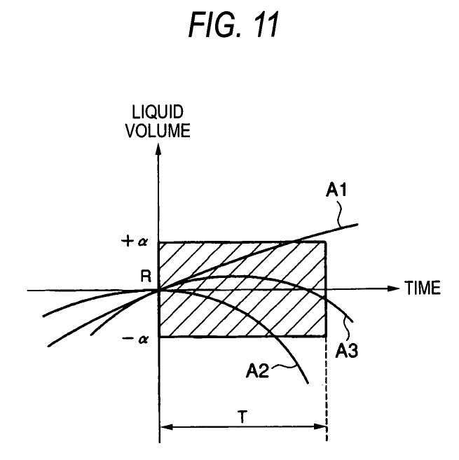

Meanwhile, in a situation where vibrations of the fuel cell unit 10, and the like, cause the liquid level to cross a predetermined threshold value frequently within a short period of time, a problem in control may occur. To prevent occurrence of such a situation, for instance, as shown in FIG. 11, tolerances are provided for the respective threshold values (an allowable range: −α to +α); and, for instance, a predetermined period of time T is measured from a point in time where a liquid level crosses a threshold value. Meanwhile, at that point in time, a control mode or switching of a state is also switched. When the liquid level does not deviate from the allowable range within the predetermined period of time T, the current control mode or the current state is maintained (not switched); and when the liquid level deviates from the allowable range within a predetermined period of time, or when the predetermined period of time T has elapsed, switching to an appropriate control mode or to an appropriate state is performed.

For instance, when, as indicated by a curve A1 or a curve A2 in FIG. 11, a liquid level after passage through a threshold value R deviates from an allowable range before the predetermined period of time T has elapsed, switching to an appropriate mode or an appropriate state at the point in time is performed. Meanwhile, when, as indicated by a curve A3, the liquid level does not deviate from the allowable range before the predetermined period of time T has elapsed, switching of a control mode or a state is not performed until the predetermined period of time T has elapsed. However, after the predetermined period of time T has elapsed, switching to an appropriate control mode or an appropriate state is performed as usual.

As described above, according to the embodiment, control for preventing excessive rise or fall of a liquid level of an aqueous fuel solution in a mixing tank is enabled, and a case where this control becomes impossible can be handled in a safe manner.

Meanwhile, the present invention is not limited to the embodiment. When being practiced, the invention can be embodied while modifying the constituent elements within the scope of the invention. In addition, a variety of inventions can be realized by means of appropriately combining the plurality of constituent elements disclosed in the embodiment. For instance, some elements may be omitted from the elements described in embodiments. Moreover, elements used in different embodiments may be combined appropriately.

What is claimed is:

1. A fuel cell unit comprising:
a fuel cell which generates water vapor;
a mixing tank which mixes fuel and water so as to produce an aqueous fuel solution, the water in the mixing tank includes water generated by condensation of the water vapor; and
a controller which controls the condensation of the water vapor so that a volume of the aqueous fuel solution in the mixing tank falls within a predetermined range.

2. The fuel cell unit according to claim 1, further comprising:
a sensor which senses the volume of the aqueous fuel solution in the mixing tank,
wherein the controller controls the condensation of the water vapor on the basis of the sensed volume of the aqueous fuel solution by the sensor.

3. The fuel cell unit according to claim 1, wherein the mixing tank recovers water generated by condensation of the water vapor.

4. The fuel cell unit according to claim 1, further comprising:
a fan which cools the water vapor so that the water vapor is condensed to water,
wherein the controller controls the condensation of the water vapor by controlling the fan.

5. The fuel cell unit according to claim 1, further comprising:
a pump which discharges the water vapor to an outside,
wherein the controller controls a volume of water vapor by controlling the pump so as to control the condensation of water vapor.

6. The fuel cell unit according to claim 1, further comprising:
a fan which cools the water vapor so that the water vapor is condensed to the water,
wherein the mixing tank recovers water generated by condensation of the water vapor, and the fan stops rotation operation when the volume of the aqueous fuel solution is above a first value.

7. The fuel cell unit according to claim 1, further comprising:
a pump which discharges the water vapor to an outside,
wherein the mixing tank recovers water generated by condensation of the water vapor, and the pump increases an emission of the water vapor to the outside when the volume of the aqueous fuel solution is above a first value.

8. The fuel cell unit according to claim 6, wherein, when the volume of the aqueous fuel solution is above a second value which is greater than the first value, the fuel cell stops power-generation operation.

9. The fuel cell unit according to claim 1, further comprising:
a fan which cools the water vapor so that the water vapor is condensed to the water,
wherein the mixing tank recovers water generated by condensation of the water vapor, and the fan increases a rotation speed when the volume of the aqueous fuel solution is below a third value.

10. The fuel cell unit according to claim 1, further comprising:
a pump which discharges the water vapor to the outside,
wherein the mixing tank recovers water generated by condensation of the water vapor, and the pump decreases an emission of the water vapor to the outside when the volume of the aqueous fuel solution is below a third value.

11. The fuel cell unit according to claim 9, wherein, when the volume of the aqueous fuel solution is below a fourth value which is lower than the third value, the fuel cell stops power-generation operation.

12. A liquid volume control method applied to a fuel cell unit, the fuel cell unit comprising: a fuel cell and a mixing tank which mixes fuel and water so as to produce aqueous fuel solution, the water in the mixing tank includes water generated by condensation of the water vapor, the method comprising:
generating water vapor when the electric power is generated by the fuel cell; and
controlling condensation of the water vapor so that the volume of the aqueous fuel solution in the mixing tank falls within a predetermined range.

13. The liquid volume method according to claim 12, further comprising:
recovering water generated by condensation of the water vapor.

14. The liquid volume method according to claim 12, wherein the controlling cools the water vapor so that the water vapor is condensed to the water.

15. The liquid volume method according to claim 12, wherein the controlling controls a volume of the water vapor by discharging the water vapor to outside so as to control the condensation of water vapor.

16. The electric apparatus system which comprises a fuel cell unit and an information apparatus, the electric apparatus system comprising:
the information apparatus comprising:
a first connector which receives an electric power generated by the fuel cell unit; and
the fuel cell unit comprising:
a second connector which can be connected to the first connector;
a fuel cell which generates a water vapor when an electric power is generated;
a mixing tank which mixes fuel and water so as to an aqueous fuel solution, the water includes water generated by condensation of the water vapor; and
a controller which controls condensation of the water vapor so that a volume of the aqueous fuel solution in the mixing tank falls within a predetermined range.

17. The electric apparatus system according to claim 16, the fuel cell unit further comprising:
a fan which cools the water vapor so that the water vapor is condensed to water,
wherein the controller controls the condensation of the water vapor by controlling the fan.

18. The electric apparatus system according to claim 16, the fuel cell unit further comprising:
a pump which discharges the water vapor to an outside,
wherein the controller controls a volume of water vapor by controlling the pump so as to control the condensation of water vapor.
